(19) United States
(12) Patent Application Publication
(10) Pub. No.: US 2012/0257145 A1
(43) Pub. Date: Oct. 11, 2012

(54) COMPOSITE RETARDATION PLATE, COMPOSITE POLARIZING PLATE COMPRISING THE SAME AND PREPARATION METHODS FOR THOSE

(75) Inventors: Ja Young LEE, Incheon (KR); Je Hoon SONG, Suwon-si (KR); Min Seong CHO, Incheon (KR)

(73) Assignee: DONGWOO FINE-CHEM CO., LTD., Iksan-si (KR)

(21) Appl. No.: 13/441,880

(22) Filed: Apr. 8, 2012

(30) Foreign Application Priority Data
Apr. 11, 2011 (KR) 10-2011-0033386

(51) Int. Cl. G02F 1/1347; B05D 3/10; B32B 37/14; B05D 5/06

(52) U.S. Cl. 349/75; 427/535; 156/60

(57) ABSTRACT

Disclosed are a composite retardation plate, a composite polarizing plate including the same and a method for manufacturing the same. More particularly, a composite retardation plate is prepared by corona or plasma treatment of a face of a liquid crystal coating layer formed on a polymeric base film to improve adhesion therebetween and then directly providing a surface treatment coating layer above the coated film, thus being produced by a simple process without using a glass material while requiring neither an additional base material nor adhesive layer. Therefore, the retardation plate prepared as described above is desirably used as a retarder for a thin-film type display. The present invention also provides a composite polarizing plate including the above retardation plate and a method for manufacturing the foregoing.

### CROSS-REFERENCE TO RELATED APPLICATIONS

This application claims priority from Korean Patent Application No. 10-2011-0033386, filed on Apr. 11, 2011 in the Korean Intellectual Property Office, the entire disclosure of which is incorporated herein by reference.

### BACKGROUND OF THE INVENTION

1. Field of the Invention

The present invention relates to a composite retardation plate.

2. Description of the Related Art

A display such as a liquid crystal display device realizing stereoscopic images is often provided with a patterned retarder. Such a patterned retarder causes respective pattern regions to have optical axes in different directions, thus enabling different images to be transmitted to left and right eyes of a viewer wearing polarized glasses, respectively, and ultimately realizing stereoscopic images.

The patterned retarder may be prepared by forming an alignment film on a glass substrate, applying liquid crystals to the alignment film and orienting the same on the film. A light-responsive liquid crystal material may be oriented on the alignment film and then cross-linked by light irradiation such as UV, resulting in the form of a polymer liquid crystal film Herein, according to orientation direction complying with surface alignment of the alignment film, the polymer liquid crystal film may function as a retarder pattern.

As such, in the case where a glass substrate is used as a base material, it is impossible to bond a retardation plate to a polarizing plate through a roll-to-roll process. The glass substrate is also relatively expensive and entails difficulties in handling during processing, compared to film materials. Further, in order to overcome deterioration in sight sensitivity caused by high reflectivity of glass, the glass plate necessarily requires an anti-reflection coating.

In addition, when a surface treatment layer is applied to the top of the patterned retarder to reduce light reflection and/or improve surface strength thereof, the surface treatment layer is duly provided on a base film and the coated film is bonded to a liquid crystal coating layer by an adhesive or a binder, in turn entailing a difficulty in decreasing the thickness of a polarizing plate.

As for thickness reduction of a polarizing plate, a method for forming a surface treatment layer on a face of a base material, which is provided with a liquid crystal coating layer the other face thereof, was proposed. However, in this case, since a polarizer, the liquid crystal coating layer, the base material and the surface treatment layer are sequentially laminated, the polarizer must be adjacent to the liquid crystal coating layer although this cannot be bonded to the polarizer by an aqueous adhesive, thus causing a problem.

### SUMMARY

Therefore, it is an aspect of the present invention to provide a composite retardation plate simply fabricated by forming a coating on a film, and a preparation method thereof.

Another aspect of the present invention is to provide a composite retardation plate suitable for use in a thin film type display, and a preparation method thereof.

Yet another aspect of the present invention is to provide a composite polarizing plate including the composite retardation plate described above, as well as a fabrication method thereof.

In order to accomplish one or more aspects, an embodiment of the present invention provides the following.

A composite retardation plate, including: a base material; a liquid crystal coating layer formed on the base material, the liquid crystal coating layer having a first surface and a second surface opposite to the first surface and facing the base material, wherein the first surface is treated through corona or plasma discharge; and a surface treatment coating layer disposed on the first surface of the liquid crystal coating layer.

The liquid crystal coating layer may be a functional layer for delaying retardation.

The functional layer for delaying retardation is a λ/4 retardation layer including an alignment film applied on the base material and a liquid crystal optically oriented over the alignment film

The surface treatment coating layer may be at least one functional layer selected from the group consisting of a protective layer, an anti-glare layer, an anti-reflective layer, an anti-static layer and a hard coating layer.

The first surface of the liquid crystal coating layer may have a water contact angle of 30 to 83°.

The first surface of the liquid crystal coating layer may have a water contact angle of 30 to 60°.

An in-plate retardation and a thickness retardation of the liquid crystal coating layer may have a difference between before and after corona or plasma discharge treatment of not more than 3.5 nm, respectively.

An in-plate retardation and a thickness retardation of the liquid crystal coating layer may have a difference between before and after corona or plasma discharge treatment in the range of 2.5 to 3.5 nm, respectively.

The corona treatment may be performed with 200 to 300 μm².

The base material may be a polymer film or a glass substrate.

A composite polarizing plate may include the composite retardation plate, a polarizer protection film and a polarizer between the composite retardation plate and the polarizer protection film.

An adhesive layer may be formed on the bottom face of the polarizer protection film.

A method for preparing a composite retardation plate, including: preparing a base material; forming a liquid crystal coating layer on the base material, the liquid crystal coating layer having a first surface and a second surface opposite to the first surface and facing the base material; surface-treating the first surface of the liquid crystal coating layer through corona or plasma discharge; and forming a surface treatment coating layer on the first surface of the liquid crystal coating layer.

The method may further include forming an alignment film on the base material before forming the liquid crystal coating layer on the alignment film.

The base material may be a polymer film or a glass substrate.

The corona treatment may be conducted with 200 to 300 J/m².

A method for fabricating a composite polarizing plate, including: bonding the composite retardation plate to the top face of the polarizer; and bonding a polarizer protection film to the bottom face of the polarizer.

As is apparent from the foregoing, an embodiment of the present invention may provide a composite retardation plate (a surface treatment coating film having a function of retardation) advantageous for decreasing a thickness of a display, which includes layers necessary for embodying desired functions in the form of a film or coating, as well as a composite polarizing plate including the same.

An embodiment of the present invention may also provide a composite retardation plate bondable to a polarizer through a roll-to-roll process by using a film type polymer instead of glass as a base material.

The composite retardation plate of the present invention may be prepared by directly forming a surface treatment coating layer above a liquid crystal coating layer and hence not need alternative material or an adhesive layer or binder layer for adding a surface treatment layer (functional layer), and instead, may be suitably used as a retarder for a thin film type stereoscopic image display.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic view illustrating an example of a polarizing plate bonded with a composite retardation plate according to an embodiment of the present invention; and

FIG. 2 is a schematic view illustrating an example of a polarizing plate bonded with a retardation plate.

### DETAILED DESCRIPTION

It will be understood that when an element such as a layer, film, region, or substrate is referred to as being “on” another element, it can be directly on the other element or intervening elements may also be present. In contrast, when an element is referred to as being “directly on” another element, there are no intervening elements present.

According to an embodiment of the present invention, there is provided a composite retardation plate prepared by corona or plasma treatment of a face of a liquid crystal coating layer formed on a polymeric base film to improve adhesion therebetween and then directly providing a surface treatment coating layer above the coated film, thus being produced by a simple process without using a glass base material while requiring neither additional base material nor adhesive layer for adding a functional layer. Therefore, the above retardation plate may be properly used as a retarder for a thin-film type display. An embodiment of the present invention also provides a composite polarizing plate including the above retardation plate and its fabrication method.

Hereinafter, exemplary embodiments of the present invention will be described in more detail.

The composite retardation plate of an embodiment of the present invention may include a polymer base film, a liquid crystal coating layer provided thereon, and a surface treatment coating layer formed above the coated film.

The polymer base film may be any one used as a transparent film for optical use, and for example, include films having excellent transparency, mechanical strength, thermal stability, moisture shielding properties, uniform retardation, isotropy, etc.

Examples of materials for the polymer base film may include, but not limited to, any one selected from the group consisting of polyolefin resin, polyester resin, cellulose resin, polycarbonate resin, acryl resin, styrene resin, vinyl chloride resin, amid resin, imide resin, polyethersulfone resin, sulfone resin, polyetheretherketone resin, polyphenylene sulfate resin, vinylalcohol resin, vinylidene chloride resin, vinylbutyral resin, allylate resin, polyoxymethylene resin and epoxy resin.

A thickness of the polymer base film is not particularly limited, however, may range from 5 to 10 μm, and for example, 15 to 60 μm, as often used in the art. When the thickness of the polymer base film is less than 5 μm, mechanical strength may be decreased. On the other hand, if the thickness exceeds 10 μm, it is disadvantageous of decreasing the thickness of the film and is hence not preferable.

The liquid crystal coating layer may be provided on the polymer base film.

The liquid crystal coating layer may serve to delay retardation of light passing through a polarizer. The liquid crystal coating layer is not particularly limited to a layer delaying the retardation of light by a specific wavelength, however, may include a 3λ/4 retardation layer, a λ/2 retardation layer, a λ/4 retardation layer, and so forth. In particular, as often used in the art, the λ/4 retardation layer formed by applying a reactive liquid crystal material to an alignment film may be used.

The fabrication method of the λ/4 retardation layer is not particularly limited. For example, an alignment film is applied on a polymer base film and then liquid crystal is optically oriented over the alignment film, resulting in a λ/4 retardation layer. However, in the present invention, the λ/4 retardation layer is restricted to a coating form while excluding a warp-stretched λ/4 retardation film or the like.

The alignment film may be any one generally used in the art without being particular limitation and, for example, an organic alignment film.

The organic alignment film may be prepared using an alignment film composition containing acrylate, polyimide or polyamic acid. Polyamic acid is a polymer obtained by reacting diamine and dianhydride, and polyimide is an imidation product of polyamic acid, and structures thereof are not particularly limited.

The alignment film composition should maintain a proper viscosity. If the viscosity is too high, the composition does not easily or smoothly flow even when applying pressure and hence entails a difficulty in forming an alignment film having a uniform thickness. On the other hand, when the viscosity is too low, it is difficult to control a thickness of the alignment film although soldering properties are favorable. For instance, the viscosity, for example, ranges from 8 to 13 cP.

In addition, surface tension, solid content and/or volatility of a solvent may be considered. In particular, solid content influences viscosity or surface tension and hence may be controlled in consideration of both the thickness of an alignment film and curing properties thereof simultaneously.

If the solid content is too high, the viscosity is high and the thickness of the alignment film is increased. On the other hand, when the solid content is too low, a ratio of the solvent may be relatively high and hence cause a problem of spots forming after drying the solution. For instance, the solid content may range from 0.1 to 10 wt. %.

The alignment film composition may be a solution phase including solid content such as acrylate, polyimide or polyamic acid dissolved in the solvent. The solvent may be any one capable of dissolving solid content without particular limitation thereof and specifically include butyl cellosolve, γ-butyrolactone, N-methyl-2-pyrrolidone, dipropyleneglycol monomethylether, etc. The solvents described above may be suitably blended to form a uniform alignment film, in consideration of solubility, viscosity, surface tension, or the like.

Other than the aforementioned materials, the alignment film composition may further include a cross-linking agent and/or a coupling agent, in order to effectively form the alignment film.

The alignment film may be prepared by applying the alignment film composition to a face of a polymer base film.

Application of the composition may be performed by any method commonly used in the art. For instance, the alignment film composition may be directly applied to the base film by flow molding and/or an application method through air knife, gravure, reverse roll, kiss roll, spray or blade, in a suitable spreading mode.

In order to increase application efficiency of the alignment film composition, a drying process may be further included.

The drying process is not particularly limited, however, may be generally performed using a hot-air dryer or far-infrared heater. A drying temperature generally ranges from 30 to 100° C., and for example, 50 to 80° C. Also, a drying time generally ranges from 30 to 600 seconds, and for example, 120 to 600 seconds.

Thereafter, orientation may be provided to the obtained alignment film. A method for applying orientation may include such as a rubbing, photo-alignment, without being particularly limited thereto.

For instance, overall orientation may be provided to the obtained alignment film or, after applying the alignment film to a part or entire face of a base film, the treated film is subjected to exposure using a photo-mask, thus producing a patterned alignment film having different orientation directions. Also, a first photo-mask having a light-permeable part and a light-shielding part is aligned on the obtained alignment film and then exposed (first exposure).

After then, a second photo-mask having a light-permeable part and a light-shielding part which are disposed in reverse order, compared to those of the first photo-mask, is aligned, followed by exposing again (second exposure). As a result, a patterned alignment film having different optical axes is fabricated.

Light used in the exposure process is not particularly limited and may include, for example, polarized UV irradiation, ion beam or plasma beam irradiation or radiation, and the like. Among those, the polarized UV irradiation is preferably used.

The oriented alignment film may be provided with a liquid crystal coating layer.

Such a liquid crystal coating layer may be formed by applying a composition for coating liquid crystals (hereinafter, ‘a liquid crystal coating composition’) to the patterned alignment film. The liquid crystal coating composition may have optical anisotropy and include a liquid crystal compound having cross-linkable properties. For example, a reactive liquid crystal monomer (RM) may be used.

The reactive liquid crystal monomer means a monomer molecule containing an end group, which is polymerizable with mesogen capable of expressing liquid crystalline properties, to thereby have a liquid crystalline phase. By polymerizing the reactive liquid crystal monomer, a cross-linked polymer network may be obtained while maintaining liquid crystals in an aligned state. In the case where the reactive liquid crystal monomer molecule is cooled below a clearing point, it is possible to render a large area domain having a structure oriented better at a relatively low viscosity in a liquid crystalline phase, compared to use of the liquid crystal polymer having the same structure.

A liquid crystalline cross-linked network film having a large area as obtained above retains optical anisotropy and/or dielectric constant (exhibited by the liquid crystal) without alteration and, at the same time, is mechanically and thermally stable since it is fabricated in a solid thin film form.

The liquid crystal coating composition may be dissolved in a solvent and used to guarantee desired efficiency of a coating process and uniformity of a coating layer. The composition may be soluble in a solvent dissolving the liquid crystal compound to hence attain uniformity.

For instance, the reactive liquid crystal monomer may be dissolved in a specific solvent capable of dissolving the same, that is, a solvent mixture including one or two or more selected from propyleneglycol monomethylether acetate (PGMEA), methylethylketone (MEK), xylene and chloroform, to thereby prepare a liquid crystal coating composition.

Here, the content of a reactive liquid crystal monomer in the liquid crystal coating composition should be maintained in a range of 15 to 30 wt. % based on the total weight of the liquid crystal coating composition. If a concentration of the monomer is low, such as less than 15 wt. %, retardation cannot be obtained. On the other hand, when the concentration exceeds 30 wt. %, a reactive liquid crystal monomer is extracted, in turn causing a problem in forming a uniform liquid crystal coating layer.

A coating method is not particularly limited and may include, for example, pin coating, roll coating, dispensing coating, gravure coating, or the like. Depending on the coating method, the type and/or used amount of the solvent may be determined.

The liquid crystal coating layer may be applied to reach a thickness after drying of 0.1 to 10 μm. Within such a thickness range, a uniform retarder pattern may be easily formed. The solvent may be evaporated during a drying process.

The drying process is not particularly limited, and, for example, may be performed using a typical hot-air dryer or far-infrared heater. A drying temperature generally ranges from 30 to 100° C., and for example, 50 to 80° C. In addition, a drying time may range from 30 to 600 seconds, and for example, 120 to 600 seconds. Further, the drying may be conducted under the same (that is, constant) temperature condition or while increasing the temperature stepwise.

The liquid crystal coating layer formed above the alignment film is then subjected to photo cross-linking to form a patterned retarder. Light used for the photo cross-linking is not particularly limited and may be, for example, UV light.

A surface treatment coating layer according to an embodiment of the present invention may be disposed above the liquid crystal coating layer.

The surface treatment coating layer may include a variety of functional layers to provide various performances to a display. For instance, the surface treatment coating layer may include any functional layer selected from the group consisting of a protective layer, an anti-glare layer, an anti-reflective layer, an anti-static layer and a hard coating layer, but not limited thereto.

More particularly, the protective layer is for preventing surface cracks or damage of a polarizing plate and/or a patterned retardation layer.

The anti-glare layer may be a layer having microfine unevenness formed on the surface thereof by surface roughing through sand blasting, embossing, etc. or, otherwise, applying a coating solution containing transparent microparticles thereto.

The anti-reflective layer is used for preventing inhibition of sight sensibility of transmitted light due to reflection of external light on the surface of the polarizing plate, and may consist of a metal oxide thin film via vapor deposition, sputtering, etc.

An anti-static layer is introduced to prevent dust from sticking due to static electricity and may be prepared using UV curable resin containing an anti-static agent.

In addition, a hard coating layer may prevent cracks or damage to the surface of a polarizing plate and be prepared using UV curable resin such as acryl or silicon-based resins. Moreover, the hard coating layer may serve as a curable coating film having high hardness or excellent slippage properties.

The surface treatment coating layer described above may be provided on the liquid crystal coating layer obtained after corona or plasma treatment. If the surface of the liquid crystal coating layer did not undergo corona or plasma treatment, coating effect may be decreased.

The corona discharge treatment may include: applying high voltage between an electrode connected to a high voltage generator and a roll of a dielectric material; and placing or moving a liquid crystal coating layer into corona discharge occurring between the roll and the electrode. In general, the frequency of the high voltage applied between the roll and the electrode is referred to as a discharge frequency, and the discharge frequency may range from 50 Hz to 5,000 kHz, and for example, 5 to several hundreds kHz. If the discharge frequency is too low, discharge is unstable and hence a number of pin-holes may occur on the surface of the liquid crystal coating layer. On the other hand, if the discharge frequency is too high, an additional device for impedance matching is required, in turn increasing treatment costs.

The corona discharge treatment is easily performed under atmospheric conditions, and, alternatively, may also be executed in an apparatus containing any gas other than air, or a sealed apparatus or a half-sealed apparatus containing an air-mixed gas charged therein. Examples of the gas may be nitrogen, argon and/or oxygen gas.

According to an embodiment of the present invention, in the case where a λ/4 retardation layer is obtained by forming a liquid crystal coating above an alignment film, corona discharge treatment may be properly implemented with an amount of 50 to 500 J/m², for example, 200 to 300 J/m² in order to improve wettability and coating properties of the surface of the obtained layer to a standard level. If the amount of the corona discharge treatment is not included in the above range, improvement of coating properties is not satisfactory or an in-plate retardation (RO) or a thickness retardation (Rth) may be adversely influenced, and is hence hard to predict desired effects of delayed retardation.

A space between the roll and the electrode may 0.5 to 2.5 mm and, more preferably, 1.0 to 2.0 mm.

The plasma treatment used in the present invention may include vacuum glow discharge, atmospheric glow discharge, and so forth. For instance, a method disclosed in Japanese Patent Laid-Open Publication No. H6-123062, H11-293011 or H11-5857 which are incorporated herein by reference may be used.

Among plasma generators with glow discharge, there is an apparatus wherein a film to be hydrophilic is placed between two opposite electrodes and a plasma-exciting gas is introduced into the apparatus to apply high frequency voltage between the above electrodes, to cause the gas to be plasma-excited and hence execute glow discharge between the electrodes, resulting in surface treatment.

The plasma-exciting gas may refer to gases excited by plasma, i.e., argon, helium, neon, krypton, xenon, nitrogen, carbon dioxide, or the like. For instance, adding a reactive gas, which can afford a polar functional group such as carboxyl group, hydroxyl group, carbonyl group, etc. to the surface of a plastic film, to an inert gas such as argon, neon, or the like may result in a mixture useable as an exciting gas. The reactive gas may be any gas such as water vapor or ammonia, in addition to hydrogen, oxygen or nitrogen, and optionally, other low boiling point organic compounds such as lower hydrocarbons, ketone, or the like. In consideration of handling, the gas such as hydrogen, oxygen, carbon dioxide, nitrogen, water vapor, etc. may be used. Otherwise, when using water vapor, the water vapor may be admixed with a gas to form bubbling gas to be used. Alternatively, water vapor may be added and admixed with the bubbling gas.

The applied high frequency voltage may have a frequency ranging from 1 kHz to 100 kHz and, for example, 1 kHz to 10 kHz.

The plasma treatment through glow discharge may be generally classified into a treatment carried out under vacuum conditions and another treatment carried out under an atmosphere.

With regard to vacuum plasma discharge treatment through glow discharge, introducing a reactive gas is needed to maintain an atmosphere for discharging in the range of 0.005 to 20 torr, for example, 0.02 to 2 torr, thus effectively inducing the discharge.

According to an embodiment of the present invention, in order to increase processing velocity, a high power condition at as high a pressure as possible may be adopted. However, if electric field strength is raised too high, the base material is sometimes damaged.

If a gas pressure is too low, effects of surface treatment may not be attained. On the other hand, when a gas pressure is too high, sparking may occur or a coating layer may be destroyed due to excess current. In order to generate a discharge, voltage is applied between a pair (or more) of metal sheets or rods in a vacuum tank.

Although the voltage depends upon types of gases and/or pressure thereof, it may generally range from 500 to 5,000 V to generate a stable and normal glow discharge within the pressure range described above. In order to improve adhesion, the voltage may range from 2,000 to 4,000 V.

A liquid crystal coating layer, specifically, a λ/4 retardation layer may be treated by glow discharge in an amount ranging, for example, from 0.01 to 5 kV·A·minute/m² and, more preferably 0.15 to 1 kV·A·minute/m², thus acquiring good adhesion strength. In terms of optical properties, the liquid crystal coating layer may enable the in-plate retardation and thickness retardation, respectively, after corona or plasma treatment, to be 3.5 nm less than that of the same (that is, the in-plate retardation and thickness retardation, respectively,) before corona or plasma treatment. Moreover, in consideration of adhesiveness of the surface treatment coating layer, a difference in the in-plate retardation and thickness retardation, respectively, between before and after corona or plasma treatment is preferably within the range of 2.5 to 3.5 nm.

After corona or plasma treatment, the liquid crystal coating layer may advantageously have a water contact angle at a face being in contact with the surface treatment coating layer of 30 to 83°, and for example, 30 to 60°, to thereby exhibit excellent coating properties and optical anisotropy.

A method for forming a surface treatment coating layer on a liquid crystal coating layer is not particularly limited. For instance, pin coating, roll coating, dispensing coating or gravure coating may be employed, and solvent type and/or an amount thereof may be determined according to the coating method.

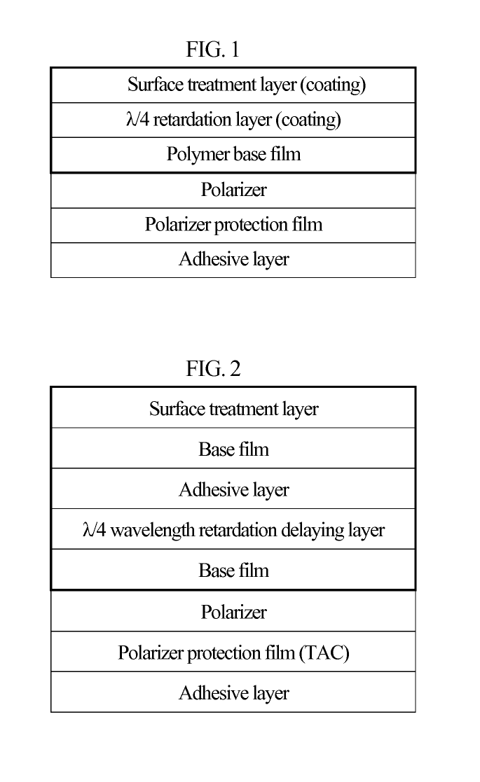

A composite retardation plate configured and prepared as described above may be bonded to any one face of a polarizer, for example, as shown in FIG. 1. (FIG. 2 shows the retardation plate and the polarizer wherein the λ/4 retardation layer is not surface-treated.) Such bonding, for example, as shown in FIG. 1, may be achieved using an adhesive or a binder generally used in film bonding in display applications.

The polarizer is not particularly limited so far as any typical polarizer having polar functions is used. For instance, using iodine or a dichroic dye may color a polyvinylalcohol film, followed by stretching the same in a predetermined direction, thereby resulting in a polarizer for use.

On the other face of the polarizer to which the composite retardation plate is not attached, a polarizer protection film may be adhered. Such a polarizer protection film may be generally a triacetylcellulose film, a cyclo-olefin film, etc.

Meanwhile, a display device having a polarizing plate and a patterned retardation layer may be provided with a composite retardation plate and a composite polarizing plate fabricated according to the embodiments of the present invention.

The display device is not particularly limited and, in particular, a semi-permeable liquid crystal display device for realizing stereoscopic images, a plasma display device, an organic EL display device, and so forth may be employed.

In this regard, the composite polarizing plate of the present invention may be placed at a position on which the polarizing plate and the patterned retardation layer are typically laminated.

Exemplary embodiments will be described to more concretely understand the present invention with reference to examples and comparative examples. However, it will be apparent to those skilled in the art that such embodiments are provided for illustrative purposes and do not limit subject matters to be protected as defined by the appended claims.

### EXAMPLE

### Examples 1 to 6 and Comparative Examples 1 to 3

### Example 1

A laminate fabricated by stacking a λ/4 retardation layer made of liquid crystals on a triacetylcellulose (TAC) film as a base film (manufactured by Fuji Co., Japan) was used. The λ/4 retardation layer of the laminate was subjected to corona treatment (74.27 J/m²) continuously two times at a power of 1.4 KW and a film velocity of 3.8 m/min.

After this, a hard coating solution was evenly applied to the corona treated face using a Mayer bar, followed by hot blow drying the same in an oven at 80° C. for 90 seconds. Then, the obtained product was photo-cured in a UV curing device to fabricate a composite retardation plate of an embodiment of the present invention, which includes a triacetylcellulose (TAC) film, a λ/4 retardation layer and a hard coating layer laminated in sequential order.

### Example 2

A composite retardation plate was prepared by the same method as described in Example 1, except that conditions for corona treatment were altered, in particular, the treatment was repeated four times (148.54 J/m²) at a power of 1.4 KW and a film velocity of 3.8 m/min.

### Example 3

A composite retardation plate was prepared by the same method as described in Example 1, except that conditions for corona treatment were altered, in particular, the treatment was repeated eight times (297.09 J/m²) at a power of 1.4 KW and a film velocity of 3.8 m/min.

### Example 4

A composite retardation plate was prepared by the same method as described in Example 1, except that the λ/4 retardation layer was subjected to plasma treatment at a power of 1.3 kW and a film velocity of 6 m/min, instead of corona treatment.

### Example 5

A composite retardation plate was prepared by the same method as described in Example 4, except that conditions for plasma treatment were altered, in particular, the treatment was performed at a power of 2.3 KW and a film velocity of 6 m/min.

### Example 6

A composite retardation plate was prepared by the same method as described in Example 4, except that conditions for plasma treatment were altered, in particular, the treatment was performed at a power of 3.3 KW and a film velocity of 6 m/min.

### Comparative Example 1

A composite retardation plate was prepared by the same method as described in Example 1, except that the λ/4 retardation layer in the laminate (manufactured by Fuji Co.) of Example 1 was used without treatment.

### Comparative Example 2

A composite retardation plate was prepared by the same method as described in Example 1, except that the laminate of Example 1 was dipped in 4.5 N KOH solution at 45° C. for 80 seconds and washed using distilled water, followed by hot blow drying the same in an oven at 80° C. for 2 minutes, to hence execute saponification of the surface of the λ/4 retardation layer.

### Comparative Example 3

A composite retardation plate was prepared by the same method as described in Comparative Example 2, except that conditions for saponification were altered, in particular, the laminate was dipped in 4.5 N KOH solution at 45° C. for 200 seconds.

### Experimental Example

For the composite retardation plates prepared in the foregoing Examples 1 to 6 and Comparative Examples 1 to 3, physical properties were measured according to the following procedures, and measured results thereof are shown in TABLE 1 below.

(1) Contact Angle

For each of Examples 1 to 6 and Comparative Examples 1 to 3, an analysis instrument (DSA100, KRUSS Co.) was used to measure a contact angle of the λ/4 retardation layer obtained after corona treatment, saponification and/or plasma treatment. Also, in the case of Comparative Example 1, the λ/4 retardation layer prepared without any treatment was subjected to measurement of the contact angle. As a test solution, water was used.

(2) Assessment of Optical Anisotropy

Using an Exo-scan meter, an in-plate retardation (RO) and a thickness retardation (Rth) of the λ/4 retardation layer at 590 nm were measured.

(3) Coating Property

After observing external appearance, spots, etc. of the surface of a hard coating layer provided on the liquid crystal layer, uniformity of the observed surface was assessed. Assessed results were classified into three levels, i.e., excellent (C), good (o) and failure (x).

TABLE 1

| | | | Variation | |
|---|---|---|---|---|
| | | | in retardation | |
| | | | value before and after | |
| | | | treatment, (nm) - | |
| | Water | Retardation | relative to | |
| | contact | value | Comparative | Coating |
| Section | angle (°) | (RO/Rth) | Example 1 | property |
| Example 1 | 80.5 | 123.1/65.3 | 0.3/1.0 | ◯ |
| Example 2 | 72.8 | 123.6/66.6 | 0.8/0.3 | ◯ |
| Example 3 | 32.0 | 119.8/69.3 | 3.0/3.0 | ⊚ |
| Example 4 | 80.56 | 122.7/66.5 | 0.1/0.2 | ◯ |
| Example 5 | 67.56 | 122.1/66.1 | 0.7/0.2 | ◯ |
| Example 6 | 42.3 | 120/69.4 | 2.8/3.1 | ⊚ |
| Comparative | 102 | 122.8/66.3 | — | X |
| Example 1 | | | | |
| Comparative | 93.5 | 121.36/65.27 | 1.44/1.03 | X |
| Example 2 | | | | |
| Comparative | 83.34 | 119.3/63.7 | 3.5/2.6 | X |
| Example 3 | | | | |

As listed in the above table, it was confirmed that each of the composite retardation plates according to the embodiments of the present invention exhibited remarkably excellent coating properties of a hard coating layer, as compared to the retardation plate without corona or plasma treatment according to the comparative examples.

Additionally, the composite retardation plates according to the embodiments of the present invention have a difference in the in-plate retardation and thickness retardation, respectively, between before and after corona or plasma treatment of 3.5 nm or less and, hence, was demonstrated to encounter no problem in terms of optical anisotropy. In particular, in Examples 3 and 6, a difference in the in-plate retardation and thickness retardation, respectively, between before and after corona or plasma treatment was within the range of 2.5 to 3.5 nm, thus demonstrating favorable coating properties without any problem in optical anisotropy.

In Examples 1, 2, 4 and 5, since a difference in the in-plate retardation and thickness retardation, respectively, between before and after corona or plasma treatment, was not more than 0.1 nm, it was confirmed that the foregoing Examples 1, 2, 4 and 5 show superior results over Examples 3 and 6, in such an aspect that a better retardation value is realized. However, in terms of coating stability, deteriorated effects were demonstrated in Examples 1, 2, 4 and 5 compared to Examples 3 and 6. Since a retardation value ranging from 2.5 to 3.5 nm of a display is not easily recognized by a viewer, it was presumed that Examples 3 and 6 having improved durability have a better applicability in consideration of a recent trend of decreasing the thickness of the display.

Furthermore, it was confirmed in all of the Examples that the liquid crystal coating layer had a water contact angle ranging from 30 to 83°, specifically, Examples 3 and 6 having better physical properties exhibited a water contact angle in the range of 30 to 60°.

While the present invention has been described with reference to the preferred embodiments, it will be understood by those skilled in the related art that various modifications and variations may be made therein without departing from the scope of the present invention as defined by the appended claims.

What is claimed is:

1. A composite retardation plate, comprising:
a base material;
a liquid crystal coating layer formed on the base material, the liquid crystal coating layer having a first surface and a second surface opposite to the first surface and facing the base material, wherein the first surface is treated through corona or plasma discharge; and
a surface treatment coating layer disposed on the first surface of the liquid crystal coating layer.

2. The composite retardation plate according to claim 1, wherein the liquid crystal coating layer is a functional layer for delaying retardation.

3. The composite retardation plate according to claim 2, wherein the functional layer for delaying retardation is a λ/4 retardation layer comprised of an alignment film applied on the base material and a liquid crystal optically oriented over the alignment film.

4. The composite retardation plate according to claim 1, wherein the surface treatment coating layer is at least one functional layer selected from the group consisting of a protective layer, an anti-glare layer, an anti-reflective layer, an anti-static layer and a hard coating layer.

5. The composite retardation plate according to claim 1, wherein the first surface of the liquid crystal coating layer has a water contact angle of 30 to 83°.

6. The composite retardation plate according to claim 1, wherein the first surface of the liquid crystal coating layer has a water contact angle of 30 to 60°.

7. The composite retardation plate according to claim 1, wherein an in-plate retardation and a thickness retardation of the liquid crystal coating layer have a difference between before and after corona or plasma discharge treatment of not more than 3.5 nm, respectively.

8. The composite retardation plate according to claim 1, wherein an in-plate retardation and a thickness retardation of the liquid crystal coating layer have a difference between before and after corona or plasma discharge treatment in the range of 2.5 to 3.5 nm, respectively.

9. The composite retardation plate according to claim 1, wherein the first surface is treated through corona, and the corona treatment is performed with 200 to 300 μm².

10. The composite retardation plate according to claim 1, wherein the base material is a polymer film or a glass substrate.

11. A composite polarizing plate including the composite retardation plate according to claim 1, a polarizer protection film and a polarizer between the composite retardation plate and the polarizer protection film.

12. The polarizing plate according to claim 11, wherein an adhesive layer is formed on the bottom face, opposite to the surface facing the polarizer, of the polarizer protection film.

13. A method for preparing a composite retardation plate, comprising:
preparing a base material;
forming a liquid crystal coating layer on the base material, the liquid crystal coating layer having a first surface and a second surface opposite to the first surface and facing the base material;
surface-treating the first surface of the liquid crystal coating layer through corona or plasma discharge; and
forming a surface treatment coating layer on the first surface of the liquid crystal coating layer.

14. The method of claim 13, further comprising forming an alignment film on the base material before forming the liquid crystal coating layer on the alignment film.

15. The method according to claim 13, wherein the base material is a polymer film or a glass substrate.

16. The method according to claim 13, wherein the corona treatment is conducted with 200 to 300 J/m².

17. A method for fabricating a composite polarizing plate, comprising:
bonding the composite retardation plate according to claim 1 to the top face of the polarizer; and
bonding a polarizer protection film to the bottom face of the polarizer.
